(19) United States
(12) Patent Application Publication
(10) Pub. No.: US 2017/0162951 A1
(43) Pub. Date: Jun. 8, 2017

(54) METHOD AND APPARATUS FOR INCREASING CHANNEL CAPACITY IN LINE OF SIGHT ENVIRONMENT

(71) Applicant: ELECTRONICS AND TELECOMMUNICATIONS RESEARCH INSTITUTE, Daejeon (KR)

(72) Inventor: Woo Yong LEE, Daejeon (KR)

(73) Assignee: ELECTRONICS AND TELECOMMUNICATIONS RESEARCH INSTIT UTE, Daejeon (KR)

(21) Appl. No.: 15/369,682

(22) Filed: Dec. 5, 2016

(30) Foreign Application Priority Data
Dec. 3, 2015 (KR) 10-2015-0171454

(51) Int. Cl. H01Q 21/29; H01Q 3/02

(52) U.S. Cl. CPC H01Q 21/29; H01Q 3/02

(57) ABSTRACT

A multiple-input and multiple-output (MIMO) communication method and apparatus is disclosed. The MIMO communication method may include setting a target channel capacity between at least one transmitting antenna and at least one receiving antenna, calculating a current channel capacity between the transmitting antenna and the receiving antenna based on a transmission signal output from the transmitting antenna, and in response to the current channel capacity not meeting the target channel capacity, changing an arrangement or an attribute of the transmitting antenna or the receiving antenna to adjust the to transmission signal output from the transmitting antenna.

### CROSS-REFERENCE TO RELATED APPLICATION(S)

This application claims the priority benefit of Korean Patent Application No. 10-2015-0171454 filed on Dec. 3, 2015, in the Korean Intellectual Property Office, the disclosure of which is incorporated herein by reference for all purposes.

### BACKGROUND

1. Field

One or more example embodiments relate to multiple-input and multiple-output to (MIMO) communication technology, and more particularly, to technology of increasing a channel capacity by changing an arrangement or an attribute of a transmitting antenna or a receiving antenna.

2. Description of Related Art

In related arts, wireless communication technology using a low carrier frequency band may be developed to be suitable to a low transmission rate in a long distance and a small bandwidth. The communication technology for a long distance using such a low carrier frequency band may use a multiple-input and multiple-output (MIMO) communication method to transmit massive data.

The MIMO communication method may be antenna-related technology to increase a channel capacity or a transmission capacity in wireless communication. In detail, the MIMO communication method may use a plurality of antennas for a transmitter and a receiver, and increase a capacity in proportion to the number of the antennas used.

In related arts, the MIMO communication method may be developed to be suitable to a non-line-of-sight (NLOS) environment in which a radio wave is sufficiently scattered. FIG. 1A is a diagram illustrating an example of MIMO communication occurring in such an NLOS environment. The NLOS environment refers to a communication environment in which an obstacle is present. A radio wave used for communication in the NLOS environment may have an increased delay time due to reflection, diffraction, scattering, and the like, and thus a time at which the radio wave arrives at a receiver may be delayed. For example, referring to FIG. 1, a radio wave transmitted from a transmitting antenna 110 may not be transmitted straightly to a receiving antenna 120 due to an obstacle 130 present in the middle, and be reflected, refracted, or scattered by a medium, for example, an indoor wall 131, to be transmitted to the receiving antenna 120.

It is generally known that MIMO communication technology is readily applicable to the NLOS environment, and applying the MIMO communication technology to a line-of-sight (LOS) environment may not be easy. Thus, it has been considered that the MIMO communication technology may be unsuitable to an outdoor LOS environment in which wave scattering hardly occurs. However, an increase in use of wireless communication has necessitated an increase in a transmission capacity or a channel capacity in the LOS environment, and accordingly researches have been conducted to apply the MIMO communication technology to the LOS environment.

A massive MIMO communication method on which research is conducted recently may include artificially inducing wave scattering to apply MIMO communication also to the LOS environment. However, such a method may require a great number of antennas, and thus an amount of calculation, or computation, and necessary electrical power may increase exponentially. In addition, an interference alignment, or neutralization, method that is suggested to overcome such an issue may present only an information-theoretic boundary, but fail to present a detailed solution.

### SUMMARY

An aspect provides a method and an apparatus for increasing a channel capacity in proportion to the number of antennas by changing an arrangement or an attribute of a transmitting antenna or a receiving antenna in multiple-input and multiple-output (MIMO) communication in a line-of-sight (LOS) environment.

According to an aspect, there is provided a MIMO communication method including setting a target channel capacity between at least one transmitting antenna and at least one receiving antenna, calculating a current channel capacity between the at least one transmitting antenna and the at least one receiving antenna based on a transmission signal output from the at least one transmitting antenna, and in response to the current channel capacity not meeting the target channel capacity, changing an arrangement or an attribute of the at least one transmitting antenna or the at least one receiving antenna, or a group to which the at least one transmitting antenna or the at least one receiving antenna belongs to adjust the transmission to signal output from the at least one transmitting antenna.

The changing may include changing the arrangement or the attribute of the at least one transmitting antenna or the at least one receiving antenna to adjust a phase of the transmission signal.

The changing may include changing the arrangement or the attribute of the at least one transmitting antenna or the at least one receiving antenna, or the group to which the at least one transmitting antenna or the at least one receiving antenna belongs to adjust an amplitude of the transmission signal.

The changing may include changing a distance between the at least one transmitting antenna and the at least one receiving antenna.

The changing may include changing a distance between transmitting antennas or a distance between receiving antennas.

The changing may include changing an angle between transmitting antennas or an angle between receiving antennas.

The changing may include selecting a subgroup including a portion of transmitting antennas and receiving antennas.

The changing may include changing a reactance of at least one parasitic element, and the at least one transmitting antenna or the at least one receiving antenna may include an active element and the at least one parasitic element.

The MIMO communication method may include calculating a current channel capacity between the changed at least one transmitting antenna and the changed at least one receiving antenna based on the changed arrangement or the changed attribute, or the changed group, and changing, based on the calculated current channel capacity, the changed arrangement or the changed attribute, or the changed group.

The setting may include setting the target channel capacity to be a preset rate of a maximum channel capacity or a mean channel capacity calculated based on the arrangement or the attribute of the at least one transmitting antenna or the at least one receiving antenna, or the group to which the at least one transmitting antenna or the at least one receiving antenna belongs.

According to another aspect, there is provided a MIMO communication apparatus including a channel capacity setter configured to set a target channel capacity between at least one transmitting antenna and at least one receiving antenna, a channel capacity calculator configured to calculate a current channel capacity between the at least one transmitting antenna and the at least one receiving antenna based on a transmission signal output from the at least one transmitting antenna, and in response to the current channel capacity not meeting the target channel capacity, an antenna changer configured to change an arrangement or an attribute of the at least one transmitting antenna or the at least one receiving antenna, or a group to which the at least one transmitting antenna or the at least one receiving antenna belongs to adjust the transmission signal output from the at least one transmitting antenna.

The antenna changer may change a distance between the at least one transmitting antenna and the at least one receiving antenna, a distance between transmitting antennas, a distance between receiving antennas, an angle between the transmitting antennas, or an angle between the receiving antennas, or select a subgroup including a portion of the transmitting antennas and the receiving antennas.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1A is a diagram illustrating an example of multiple-input and multiple-output to (MIMO) communication occurring in a non-line-of-sight (NLOS) environment;

FIG. 1B is a diagram illustrating an example of MIMO communication occurring in a line-of-sight (LOS) environment according to an example embodiment;

FIG. 2 is a diagram illustrating an example of MIMO communication occurring between N transmitting antennas and M receiving antennas in the presence of a strong interference in an LOS environment according to an example embodiment;

FIG. 3 is a diagram illustrating an example of MIMO communication occurring between two transmitting antennas and two receiving antennas in the presence of a strong interference in an LOS environment according to an example embodiment;

FIG. 4 is a diagram illustrating a flow of a MIMO communication method in an LOS environment according to an example embodiment;

FIG. 5 is a diagram illustrating a MIMO communication apparatus in an LOS environment according to an example embodiment;

FIG. 6 is a diagram illustrating a simulation of MIMO communication in an LOS environment according to an example embodiment;

FIG. 7 is a graph illustrating a result of the simulation illustrated in FIG. 6.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Terms such as first, second, A, B, (a), (b), and the like may be used herein to describe components. Each of these terminologies is not used to define an essence, order or sequence of a corresponding component but used merely to distinguish the corresponding component from other component(s). For example, a first component may be referred to a second component, and similarly the second component may also be referred to as the first component.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, examples are described in detail with reference to the accompanying drawings. Like reference numerals in the drawings denote like elements, and a known function or configuration will be omitted herein.

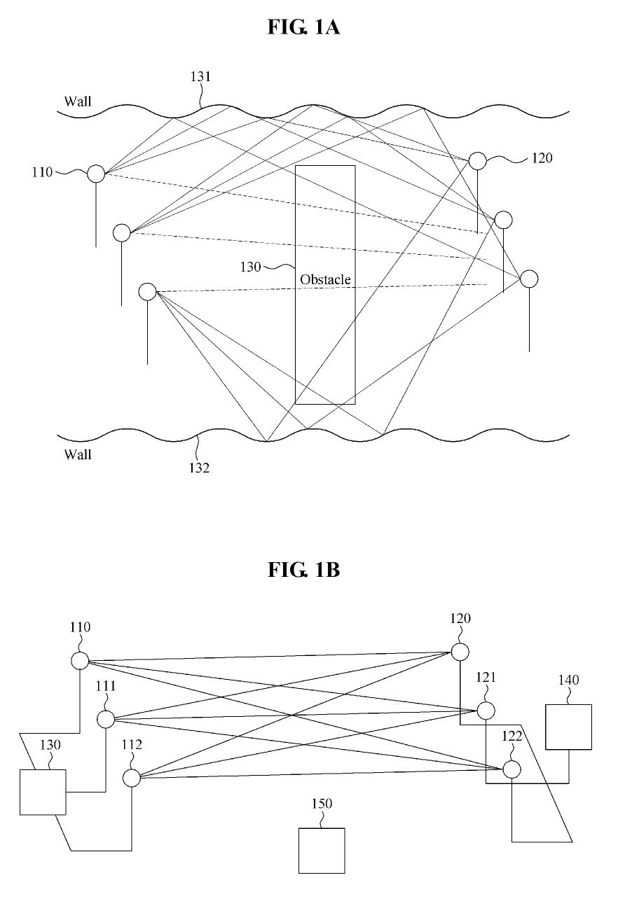

FIG. 1B is a diagram illustrating an example of multiple-input and multiple-output (MIMO) communication occurring in a line-of-sight (LOS) environment according to an example embodiment.

Dissimilar to a non-line-of-sight (NLOS) environment, an LOS environment refers to a communication environment in which an obstacle is not present. That is, the LOS environment may be a communication environment in which a radio wave used for communication does not experience, for example, reflection, diffraction, and scattering. In such an LOS environment, a radio wave may not have multiple paths because the radio wave is not reflected, diffracted, and scattered, and thus an issue of a transmission delay time that may be caused by such multiple paths may not arise. For example, the LOS environment refers to an outdoor environment without an obstacle.

Referring to FIG. 1B, dissimilar to the example illustrated in FIG. 1A, the LOS environment does not include the obstacle 130 in the middle and the medium 131 forming multiple paths, which are illustrated in FIG. 1A. Thus, a transmitting antenna, for example, a transmitting antenna 110, a transmitting antenna 111, and a transmitting antenna 112, may transmit a radio wave directly to a receiving antenna, for example, a receiving antenna 120, a receiving antenna 121, and a receiving antenna 122. However, in response to an increase in the number of antennas, the number of radio waves to be transmitted from each transmitting antenna to each receiving antenna may increase, and such an increase in the number of the radio waves may increase an interference among the radio waves.

In a MIMO communication method according to an example embodiment, a transmitter 130 may set a target channel capacity between at least one transmitting antenna and at least one receiving antenna, and calculate a current channel capacity between the transmitting antenna and the receiving antenna based on a transmission signal output from the transmitting antenna. In response to the current channel capacity not meeting the target channel capacity, the transmitter 130 may change an arrangement or an attribute of the transmitting antenna or the receiving antenna, or a group to which the transmitting antenna or the receiving antenna belongs to adjust the transmission signal output from the transmitting antenna. That is, the transmitter 130 may control the MIMO communication method.

In the MIMO communication method according to another example embodiment, a receiver 140 may set a target channel capacity between at least one transmitting antenna and at least one receiving antenna, and calculate a current channel capacity between the transmitting antenna and the receiving antenna based on a transmission signal output from the transmitting antenna. In response to the current channel capacity not meeting the target channel capacity, the receiver 140 may change an arrangement or an attribute of the transmitting antenna or the receiving antenna, or a group to which the transmitting antenna or the receiving antenna belongs to adjust the transmission signal output from the transmitting antenna. That is, the receiver 140 may control the MIMO communication method.

In the MIMO communication method according to still another example embodiment, an external controller 150 may set a target channel capacity between at least one transmitting antenna and at least one receiving antenna, and calculate a current channel capacity between the transmitting antenna and the receiving antenna based on a transmission signal output from the transmitting antenna. In response to the current channel capacity not meeting the target channel capacity, the external controller 150 may change an arrangement or an attribute of the transmitting antenna or the receiving antenna, or a group to which the transmitting antenna or the receiving antenna belongs to adjust the transmission signal output from the transmitting antenna. That is, the external controller 150 may control the MIMO communication method.

Here, when the arrangement or the attribute of the transmitting antenna or the receiving antenna, or the group to which the transmitting antenna or the receiving antenna belongs changes, an amplitude or a phase of the transmission signal may change.

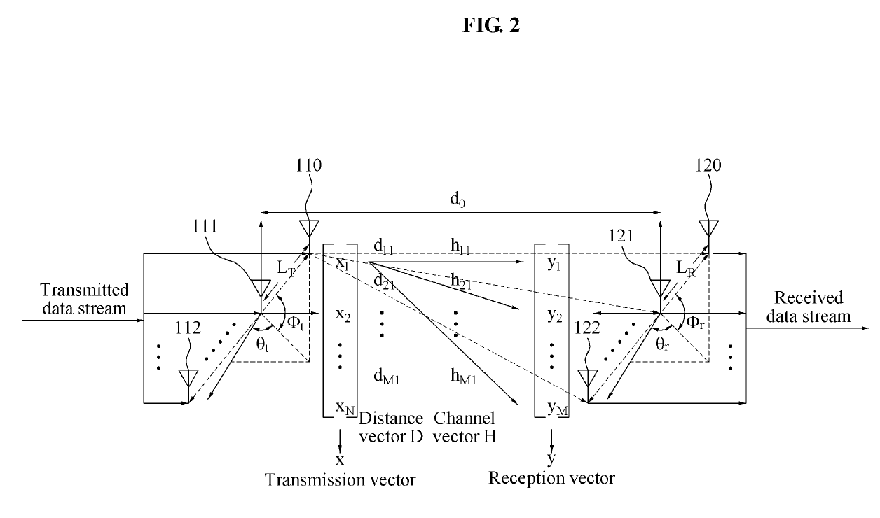

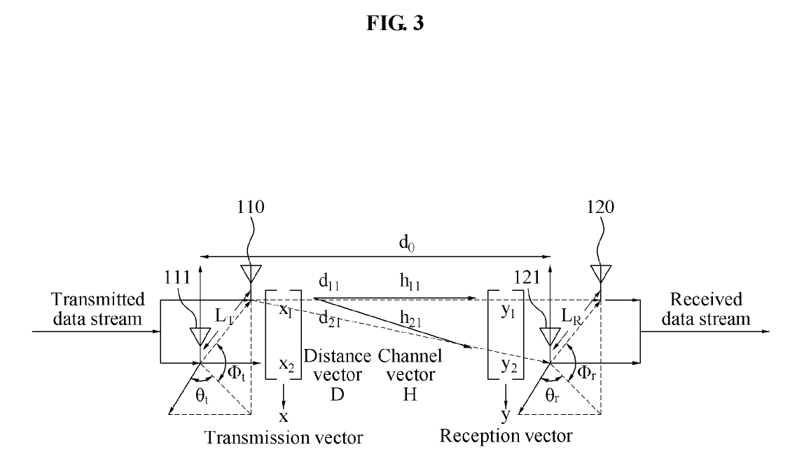

Hereinafter, a method of obtaining a current channel capacity and a maximum channel capacity will be described with reference to FIGS. 2 and 3.

FIG. 2 is a diagram illustrating an example of MIMO communication occurring between N transmitting antennas and M receiving antennas in the presence of a strong interference in an LOS environment according to an example embodiment.

A transmission data stream, or a transmitted data stream as illustrated in FIG. 2, may be wirelessly transmitted to a plurality of receiving antennas through a plurality of transmitting antennas, and signals received by the receiving antennas may form a reception data stream, or a received data stream as illustrated in FIG. 2.

Referring to FIG. 2, a plurality of transmitting antennas, for example, a transmitting antenna 110, a transmitting antenna 111, and a transmitting antenna 112, may be one-dimensionally arranged in a three-dimensional (3D) space. For example, the transmitting antenna 110 may be arranged at a location that is separated by a distance Lₜ, or a length, in a direction of an azimuth θₜ and an elevation φₜ from the transmitting antenna 111. In addition, a plurality of receiving antennas, for example, a receiving antenna 120, a receiving antenna 121, and a receiving antenna 122, may be one-dimensionally arranged in the 3D space. For example, the receiving antenna 120 may be arranged at a location that is separated by a distance Lᵣ, or a length, in a direction of an azimuth θᵣ and an elevation φᵣ from the receiving antenna 121. The plurality of transmitting antennas or the plurality of receiving antennas may be two-dimensionally or three-dimensionally arranged.

A transmission signal to be transmitted from each transmitting antenna and a reception signal to be received by each receiving antenna may be represented by a transmission vector x ∈ C^{N×1} and a reception vector y ∈ C^{M×1}, respectively. A relationship between the transmission vector and the reception vector may be represented as follows.

y=H×x+n

H ∈ C^{M×N} denotes a channel vector, in which H is referred to as a channel matrix or a complex channel matrix. n ∈ C^{M×1} denotes additive white Gaussian noise (AWGN) having a covariance of N₀×I_{N}, a type of noise, in which I_{N} denotes a N-dimensional identity matrix. In a complete LOS environment, a (m, n)-th channel gain hₘₙ of the channel vector H may have a relationship with a wavelength λ of a transmission signal and an effective communication distance dₘₙ from an n-th transmitting antenna to an m-th receiving antenna.

$${h}_{mn} = \frac{λ}{4 {πd}_{m \cdot n}} {e}^{- j \frac{2 n}{λ} {d}_{mn}}$$

The effective communication distance dₘₙ may be represented by the following equation.

$${d}_{mn} = \sqrt{{{d}_{0}^{2} ( ( m - 1 ) {L}_{R} \vert cos {θ}_{r} cos {∅}_{r} \vert + ( n - 1 ) {L}_{T} \vert cos {θ}_{t} cos {∅}_{t} \vert )}^{2}}$$

When it is assumed that dₘₙ>>Lₜ, Lᵣ, the effective communication distance dₘₙ may be approximated as follows.

$${d}_{mn} ≅ {d}_{0} + \frac{{( ( m - 1 ) {L}_{R} \vert cos {θ}_{r} cos {∅}_{r} \vert + ( n - 1 ) {L}_{T} \vert cos {θ}_{r} cos {∅}_{r} \vert )}^{2}}{2 {d}_{0}}$$

Hereinafter, limiting the number of antennas to a certain number, and more simplified equations will be described with reference to FIG. 3.

FIG. 3 is a diagram illustrating an example of MIMO communication occurring between two transmitting antennas and two receiving antennas in the presence of a strong interference in an LOS environment according to an example embodiment.

In the example illustrated in FIG. 3, respective values of M and N are limited to two (M=2, N=2). Here, the channel vector H may be defined as follows.

$$H = [ \begin{matrix}{h}_{11} & {h}_{12} \\ {h}_{21} & {h}_{22}\end{matrix} ] = [ \begin{matrix}\frac{λ}{4 π {d}_{11}} \text{?} & \frac{λ}{4 π {d}_{12}} \text{?} \\ \frac{λ}{4 π {d}_{21}} \text{?} & \frac{λ}{4 π {d}_{22}} \text{?}\end{matrix} ]$$

$$\text{?} \text{indicates text missing or illegible when filed}$$

When it is assumed that dₘₙ>>Lₜ, Lᵣ, the channel vector H may be approximated as follows.

$$H ≅ \frac{λ}{4 π {d}_{0}} \text{?} [ \begin{matrix}1 & \text{?} \\ \text{?} & 1\end{matrix} ]$$

$$\text{?} \text{indicates text missing or illegible when filed}$$

A Shannon capacity of an N×N MIMO channel having the channel vector H may be maximized when N singular values of the channel vector H are present and identical to one another. It indicates that rows of the matrix H needs to be orthogonal. That is, an inner product among the rows of the matrix H is zero. By applying such a condition to a 2×2 MIMO channel, the following equation may be obtained.

$$( \begin{matrix}1 & \text{?}\end{matrix} ) ⊗ ( \begin{matrix}\text{?} & 1\end{matrix} ) = 0$$

$$\text{?} \text{indicates text missing or illegible when filed}$$

When it is assumed that L_{T}|cos θₜ cos φₜ|=L_{R}|cos θᵣ cos φᵣ|=L|cos θ cos φ|, the preceding equation may be approximated as follows.

$$0 = \text{?} + \text{?} = 2 cos \frac{π {L}^{2} {\vert cos θ cos ∅ \vert}^{2}}{λ {d}_{0}}$$

$$\text{?} \text{indicates text missing or illegible when filed}$$

The preceding equation may be arranged as follows, in which k denotes a natural number.

$${L}^{2} {\vert cos θ cos ∅ \vert}^{2} = \frac{λ {d}_{0}}{2} ( 2 k - 1 )$$

The preceding equation may be expanded as follows to a case in which the number of transmitting antennas is N and the number of receiving antennas is M, in which M≦N.

$${L}_{T} \vert cos {θ}_{t} cos {∅}_{r} \vert {L}_{R} \vert cos {θ}_{t} cos {∅}_{r} \vert = \frac{λ {d}_{0}}{M ( 1 - 1 )} k \qquad [ Equation 1 ]$$

In Equation 1, 1,1′ ∈[1 . . . M].

Here, an N×M MIMO channel capacity C may be given as follows. Based on the given equation below, a current channel capacity may be calculated. A channel capacity may indicate a concept including the number of data streams or ranks, a transmission rate, a transmission distance, and a reception signal-to-noise ratio (SNR).

$$C = max \text{?} {log}_{2} det ( {I}_{M} + \text{?} {HR}_{xx} {H}^{H} ) bps \text{/} Hz$$

$$\text{?} \text{indicates text missing or illegible when filed}$$

In the preceding equation, Rₓₓ denotes a covariance matrix of an input signal, and I_{M} denotes an M-dimensional identity matrix. When the covariance matrix Rₓₓ of the input signal is assumed to be equal to I_{M} (Rₓₓ=I_{M}), the preceding equation may be simplified as follows. Based on this, the current channel capacity may be calculated.

$$C = {log}_{2} det ( {I}_{M} + \text{?} {HH}^{H} )$$

$$\text{?} \text{indicates text missing or illegible when filed}$$

For example, when it is assumed that the number of transmitting antennas is two and the number of receiving antennas is two, HH^{H} may be represented as follows.

$${HH}^{H} ≅ {( \begin{matrix}λ \\ \text{?}\end{matrix} )}^{2} [ \begin{matrix}1 & \text{?} \\ \text{?} & 1\end{matrix} ] [ \begin{matrix}1 & \text{?} \\ \text{?} & 1\end{matrix} ]$$

$$\text{?} \text{indicates text missing or illegible when filed}$$

A determinant of a matrix for calculating a channel capacity may be obtained as follows.

$$det ( {I}_{N} + \text{?} {HH}^{H} ) - {( 1 + \text{?} {( \frac{λ}{4 π {d}_{0}} )}^{2} )}^{2} - {( \frac{{E}_{x}}{2 {N}_{0}} {( \frac{λ}{4 π {d}_{0}} )}^{2} )}^{2} ( 2 + \text{?} + \text{?} )$$

$$\text{?} \text{indicates text missing or illegible when filed}$$

Thus, the channel capacity C may be represented as follows. Based on this, the current channel capacity may be calculated.

$$C = {log}_{2} \{ 1 + \frac{2 {E}_{x}}{{N}_{0}} {( \text{?} )}^{2} + \frac{{E}_{x}^{2}}{2 {N}_{0}^{2}} {( \frac{λ}{4 π {d}_{0}} )}^{4} ( 1 - cos [ \text{?} + \text{?} ] ) \}$$

$$\text{?} \text{indicates text missing or illegible when filed}$$

In the preceding equation, when it is assumed that L_{T}|cos θₜ cos φₜ|=L_{R}|cos θᵣ cos φᵣ|=L|cos θ cos φ|, HH^{H} and the channel capacity C may be represented as follows. Based on this, the current channel canacity may he calculated.

$${HH}^{H} ≅ {( \frac{λ}{4 π {d}_{0}} )}^{2} [ \begin{matrix}2 & 2 cos ( π \frac{{L}^{2} {\vert cos θcos ∅ \vert}^{2}}{λ {d}_{0}} ) \\ 2 cos ( π \frac{{L}^{2} {\vert cos θcos∅ \vert}^{2}}{λ {d}_{0}} ) & 2\end{matrix} ]$$

$$0 - log \text{?} ( {I}_{M} + \frac{E \text{?}}{2 N \text{?}} {( \frac{λ}{4 π {d}_{0}} )}^{2} [ \begin{matrix}2 & 2 cos ( π \begin{matrix}{L}^{2} {\vert cos θcos ∅ \vert}^{2} \\ λ {d}_{0}\end{matrix} ) \\ 2 cos ( π \frac{{L}^{2} {\vert cos θcos∅ \vert}^{2}}{λ {d}_{0}} ) & 2\end{matrix} ] )$$

$$\text{?} \text{indicates text missing or illegible when filed}$$

In the preceding equation, a maximum value Cₘₐₓ of the channel capacity C may be obtained when

$${L}^{2} {\vert cos θcos ∅ \vert}^{2} = \frac{\text{?}}{2} , \\ \text{?} \text{indicates text missing or illegible when filed}$$

and the maximum value Cₘₐₓ may be represented as follows.

$${C}_{max} = 2 {log}_{2} ( 1 + \frac{E \text{?}}{{N}_{0}} {( \frac{λ}{4 π {d}_{0}} )}^{2} )$$

$$\text{?} \text{indicates text missing or illegible when filed}$$

The preceding equation may be expanded as follows to a case in which the number of transmitting antennas is N and the number of receiving antennas is M, in which M≦N.

$${C}_{max} = M {log}_{2} ( 1 + M \frac{E \text{?}}{2 {N}_{o}} {( \frac{λ}{4 π {d}_{0}} )}^{2} )$$

$$\text{?} \text{indicates text missing or illegible when filed}$$

In the preceding equation, the maximum value Cₘₐₓ of the channel capacity C may be obtained when

$${L}_{T} \vert cos {θ}_{t} cos {∅}_{t} \vert {L}_{R} \vert cos {θ}_{r} cos {∅}_{r} \vert ≡ \frac{λ {d}_{0}}{M ( 1 - 1 )} k ,$$

in which k denotes a natural number.

According to an example embodiment, a MIMO communication apparatus may select the number of transmitting antennas and receiving antennas to obtain a target channel capacity based on a first channel state, for example, a channel bandwidth, a modulation and coding scheme (MCS), and an available transmitting and receiving antenna.

The MIMO communication apparatus may assume that

$$cos {θ}_{t} = cos {∅}_{t} = cos {θ}_{r} = cos {∅}_{r} = 1$$

in Equation 1 above, and select an arrangement or an attribute of a transmitting antenna or a receiving antenna or a group to which the transmitting antenna or the receiving antenna belongs, from a range satisfying

$${L}_{T} {L}_{R} \leq \frac{λ {d}_{0}}{M ( 1 - 1 )} k .$$

Here, the group refers to a group including at least one antenna of different base stations.

The MIMO communication apparatus may discover a group of transmitting and receiving antennas that satisfies Equation 1 by adjusting an arrangement or an attribute of antennas in a selected group. For example, the MIMO communication apparatus may change a group of antennas of different base stations, and discover a group of transmitting antennas and receiving antennas that satisfies Equation 1. Here, Cₘₐₓ may be the target channel capacity. In the absence of the group of the transmitting antennas and the receiving antennas that satisfies Equation 1, the MIMO communication apparatus may determine that the target channel capacity is not to be met.

According to another example embodiment, the target channel capacity may be a value approximating to Cₘₐₓ. For example, the MIMO communication apparatus may set a preset rate of Cₘₐₓ to be the target channel capacity.

Hereinafter, a method of calculating a mean channel capacity, or a mean channel capacity value, will be described.

To analyze a channel capacity in a case that the number of transmitting antennas is two and the number of receiving antennas is two, a probability density function (PDF), a cumulative density function (CDF), and a mean channel capacity value (expectation of capacity) may be analyzed as follows.

To simplify such an analysis, a PDF f(u) is assumed to have an independent and uniform distribution at an antenna separation distance L.

$$f ( u ) = \frac{1}{L} for 0 \leq u \leq L$$

In the preceding equation, when x=L_{cos} θ, dx=−Lₛᵢₙ θdθ. Thus, a CDF F(u) may be represented by the following equation.

$$F ( u ) = \int f ( u ) du = {\int }_{0}^{2} f ( x ) dx = {\int }_{0}^{\frac{n}{2}} sin θ d θ$$

$$for 0 \leq θ \leq n 2$$

Thus, a mean channel capacity value Cₘₑₐₙ may be represented by the following equation.

$${C}_{mean} = {\int }_{0}^{\frac{π}{2}} \text{?} {θlog}_{2} ( {\{ 1 + \frac{E \text{?}}{{N}_{0}} {( \frac{λ}{4 π {d}_{0}} )}^{2} \}}^{2} - {\{ \frac{E \text{?}}{{N}_{0}} {( \frac{λ}{4 π {d}_{0}} )}^{2} cos ( π \frac{{L}^{2} {\vert cos θcos ∅ \vert}^{2}}{λ {d}_{0}} ) \}}^{2} ) d θ$$

$$\text{?} \text{indicates text missing or illegible when filed}$$

When

$$\text{?} = \frac{E \text{?}}{{N}_{0}} {( \frac{λ}{4 π d \text{?}} )}^{2} and A ≡ π \frac{{L}^{2} {\vert cos ∅ \vert}^{2}}{λ {d}_{0}} , \\ \text{?} \text{indicates text missing or illegible when filed}$$

the preceding equation may be simply represented by the following equation.

$${C}_{mean} = {\int }_{0}^{\frac{π}{2}} sin {θlog}_{2} ( {\{ 1 + σ \}}^{2} - {\{ σ cos ( A {\vert cos θ \vert}^{2} ) )}^{2} ) d θ$$

The preceding equation may be calculated to approximate to the following equation.

$${C}_{mean} = {\int }_{0}^{1} {log}_{2} ( {\{ 1 + σ \}}^{2} - {\{ \text{?} cos ( A {\vert cos θ \vert}^{2} ) )}^{2} ) d cos θ ≅ {log}_{2} ( {\{ 1 + \frac{E \text{?}}{{N}_{0}} {( \frac{λ}{4 π d \text{?}} )}^{2} \}}^{2} - {\{ \frac{\sqrt{λ {d}_{0}}}{\text{?}} \frac{E \text{?}}{{N}_{0}} {( \frac{λ}{\text{?}} )}^{2} \}}^{2} )$$

$$\text{?} \text{indicates text missing or illegible when filed}$$

The mean channel capacity value Cₘₑₐₙ may be accurately analyzed as follows.

Since a condition

$$- 1 < \frac{σ}{1 + \text{?}} cos ( A {\vert cos θ \vert}^{2} ) \leq 1$$

$$\text{?} \text{indicates text missing or illegible when filed}$$

is satisfied, the mean channel capacity value Cₘₑₐₙ may be represented by the following equation.

$${C}_{mean} = 2 {log}_{0} ( 1 + \text{?} ) - 2 log \text{?} 2 {\sum }_{i = 1}^{∞} ( \frac{σ}{1 + σ} ) \text{?} {\int }_{0}^{1} \{ cos ( A {\vert cos θ \vert}^{2} ) ) \text{?} d cos θ - 2 {log}_{2} ( 1 + \text{?} ) - 2 {log}_{θ} 2 {\sum }_{i = 1}^{∞} ( \frac{σ}{1 + σ} ) \text{?} [ \frac{1}{2 \text{?}} ( \begin{matrix}2 \text{?} \\ 1\end{matrix} ) + \frac{1}{2 \text{?}} \{ 1 \vert {\sum }_{n = 1}^{∞} \begin{matrix}{( - 1 )}^{n} {( 21 A )}^{2 n} \\ ( 2 n ) \vert ( 4 n + 1 )\end{matrix} \vert ( \begin{matrix}21 \\ 1\end{matrix} ) [ 1 \vert {\sum }_{n = 1}^{∞} \begin{matrix}\text{?} {( 21 - \text{?} )}^{2 n} \\ ( 2 n ) \vert ( 4 n + 1 )\end{matrix} ] \vert … + ( \begin{matrix}21 \\ \begin{matrix}1 & 1\end{matrix}\end{matrix} ) [ 1 + {\sum }_{n = 1}^{∞} \frac{{( - 1 )}^{n} {( 2 A )}^{2 n}}{( 3 n ) \vert ( 4 n \vert 1 )} ] \} ]$$

$$\text{?} \text{indicates text missing or illegible when filed}$$

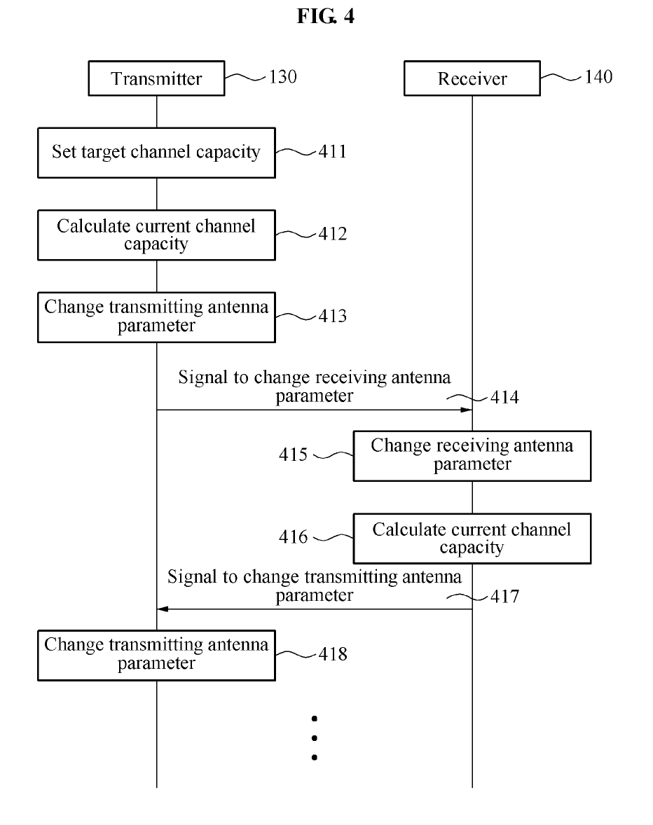

FIG. 4 is a diagram illustrating a flow of a MIMO communication method in an LOS environment according to an example embodiment. Here, a transmitter 130 and a receiver 140 may control the MIMO communication method.

Referring to FIG. 4, in operation 411, the transmitter 130 sets a target channel capacity between at least one transmitting antenna and at least one receiving antenna. The target channel capacity may be a value set by a user in advance.

In operation 412, the transmitter 130 calculates a current channel capacity between the transmitting antenna and the receiving antenna based on a transmission signal output from to the transmitting antenna. For example, in a case that the number of transmitting antennas is M and the number of receiving antennas is N, a channel capacity C may be calculated by the following equation.

$$C = max {\text{?}}_{( {R}_{XX} ) = N} {log}_{2} det ( {I}_{M} + \frac{E \text{?}}{{NN}_{0}} {HR}_{XX} {H}^{H} ) bps \text{/} Hz$$

$$\text{?} \text{indicates text missing or illegible when filed}$$

For example, in a case that the number of transmitting antennas is two and the number of receiving antennas is two, a channel capacity C may be calculated by the following equation.

$$C = {log}_{1} \{ 1 + \frac{2 {E}_{N}}{{N}_{0}} {( \frac{λ}{4 π {d}_{0}} )}^{2} + \frac{{E}_{N}^{2}}{2 {N}_{0}^{2}} ( \frac{λ}{4 π {d}_{0}} ) \text{?} ( 1 - cos ⌊ \frac{x}{λ {d}_{0}} ( {L}_{T}^{2} {\vert cos {θ}_{t} cos {∅}_{t} \vert}^{2} + {L}_{R}^{2} {\vert cos {θ}_{r} + cos {∅}_{r} \vert}^{2} ) ⌋ ) \}$$

$$\text{?} \text{indicates text missing or illegible when filed}$$

That is, when a wavelength λ is determined by a given frequency band, the current channel capacity may be changed by an azimuth θₜ, an elevation φₜ, and a distance Lₜ between transmitting antennas, and an azimuth θᵣ, an elevation φᵣ, and a distance Lᵣ between receiving antennas. In addition, the current channel capacity may be changed by a distance d₀ between a reference point of the transmitting antenna and a reference point of the receiving antenna.

The current channel capacity may be a state in which a data transmission rate is limited by an interference among transmission signals. In operation 413, in response to the current channel capacity not meeting the target channel capacity, the transmitter 130 adjusts the transmission signal output from the transmitting antenna by changing an arrangement or an attribute of the transmitting antenna or a group to which the transmitting antenna belongs.

For example, when 1≦i and j≦N and an i-th transmitting antenna transmits a signal to a j-th receiving antenna, the i-th transmitting antenna may change N transmission signals by changing an arrangement or an attribute of the transmitting antenna or a group to which the transmitting antenna belongs, so that N−1 transmission signals, which are not transmitted from the i-th transmitting antenna and are to be eliminated in the j-th receiving antenna. That is, the transmitter 130 may predict an interference to affect the receiver 140 by calculating the current channel capacity, and then change transmission signals to eliminate the interference and approximate the current channel capacity to the target channel capacity.

According to an example embodiment, the transmitter 130 may change a transmission signal by changing the distance d₀ between the reference point of the transmitting antenna and the reference point of the receiving antenna. In response to the change of the transmission signal, the current channel capacity may approximate to the target channel capacity.

According to another example embodiment, the transmitter 130 may change a transmission signal by changing a distance Lₜ between transmitting antennas. In response to the change of the transmission signal, the current channel capacity may approximate to the target channel capacity.

According to still another example embodiment, the transmitter 130 may change a transmission signal by changing an angle between transmitting antennas. In detail, the transmitter 130 may change a transmission signal by changing an azimuth θₜ or an elevation φₜ between transmission antennas. In response to the change of the transmission signal, the current capacity may approximate to the target channel capacity.

According to yet another example embodiment, the transmitter 130 may change a transmission signal by selecting a subgroup including a portion of transmitting antennas. In detail, although an arrangement of the transmitting antennas is fixed, a distance Lₜ or an angle, for example, an azimuth 0ₜ and an elevation φₜ, between transmitting antennas may change by selecting a transmitting antenna. In response to the change of the transmission signal, the current channel capacity may approximate to the target channel capacity.

According to further another example embodiment, when the transmitting antenna includes a single active element and a plurality of parasitic elements, the transmitter 130 may change a transmission signal by changing a reactance of at least one of the parasitic elements.

For example, the transmitting antenna may be an electronically steerable parasitic array radiator (ESPAR). In response to the change of the transmission signal, the current channel capacity may approximate to the target channel capacity.

In operation 414, the transmitter 130 calculates the current channel capacity between the transmitting antenna and the receiving antenna based on the changed arrangement or attribute, or the changed group. When the calculated current channel capacity does not meet the target channel capacity, the transmitter 130 may transmit, to the receiver 140, a signal to change an arrangement or an attribute of the receiving antenna, or a group to which the receiving antenna belongs.

In operation 415, the receiver 140 changes the arrangement or the attribute of the receiving antenna, or the group to which the receiving antenna belongs, based on the signal received by the receiver 140 from the transmitter 130. Here, the arrangement or the attribute, or the group to be changed may include, for example, the distance d₀ between the reference point of the transmitting antenna and the reference point of the receiving antenna, a distance Lᵣ between receiving antennas, and an angle between the receiving antennas (i.e., an azimuth θᵣ or an elevation φᵣ), and a subgroup including receiving antennas.

According to another example embodiment, when the receiving antenna includes a single active element and a plurality of parasitic elements, the receiver 140 may change a transmission signal by changing a reactance of at least one of the parasitic elements. For example, the receiving antenna may be an ESPAR. In response to the change of the transmission signal, the current channel capacity may approximate to the target channel capacity.

In operation 416, the receiver 140 calculates a current channel capacity again based on the changed arrangement or attribute of the receiving antenna, or the changed group. In operation 417, in response to the current channel capacity not meeting the target channel capacity, the receiver 140 transmits, to the transmitter 130, a signal to change an arrangement or an attribute of the transmitting antenna, or a group to which the transmitting antenna belongs. In operation 418, the transmitter 130 changes the arrangement or the attribute of the transmitting antenna, or the group to which the transmitting antenna belongs, based on the signal received from the receiver 140.

According to an example embodiment, the operations described with reference to FIG. 4 may be repetitively performed until the current channel capacity reaches the target channel capacity. According to another example embodiment, the operations may be repetitively performed until a certain standard or level is satisfied. Here, the standard or level may indicate that, for example, the current channel capacity reaches a preset rate of the target channel capacity and the number of repetitions reaches a preset value.

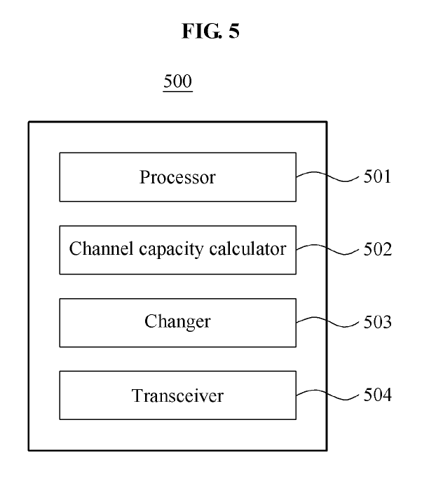

FIG. 5 is a diagram illustrating a MIMO communication apparatus 500 in an LOS environment according to an example embodiment.

According to an example embodiment, the MIMO communication apparatus 500 may be the transmitter 130. In such a case, a MIMO communication method may be controlled by the transmitter 130. According to another example embodiment, the MIMO communication apparatus 500 may be the receiver 140. In such a case, the MIMO communication method may be controlled by the receiver 140. According to still another example embodiment, the MIMO communication apparatus 500 may be an external controller. In such a case, the MIMO communication method may be controlled by the external controller. According to yet another example embodiment, the MIMO communication method may be embodied by a combination of example embodiments described above.

Referring to FIG. 5, the MIMO communication apparatus 500 includes a processor 501, a channel capacity calculator 502, a changer 503, and a transceiver 504. The processor 501 may set a target channel capacity between at least one transmitting antenna and at least one receiving antenna. The channel capacity calculator 502 may calculate a current channel capacity between the transmitting antenna and the receiving antenna based on a transmission signal output from the transmitting antenna.

The processor 501 may determine whether the current channel capacity meets the target channel capacity. When the processor 501 determines that the current channel capacity does not meet the target channel capacity, the changer 503 may change an arrangement or an attribute of the transmitting antenna or the receiving antenna, or a group to which the transmitting antenna or the receiving antenna belongs to adjust the transmission signal output from the transmitting antenna.

The processor 501 may then determine again whether the current channel capacity meets the target channel capacity. When the processor 501 determines that the current channel capacity still does not meet the target channel capacity, the transceiver 504 may transmit or receive, to or from the transmitter 130 or the receiver 140, a signal to change the changed arrangement or the changed attribute of the transmitting antenna or the receiving antenna, or the changed group to which the transmitting antenna or the receiving antenna belongs.

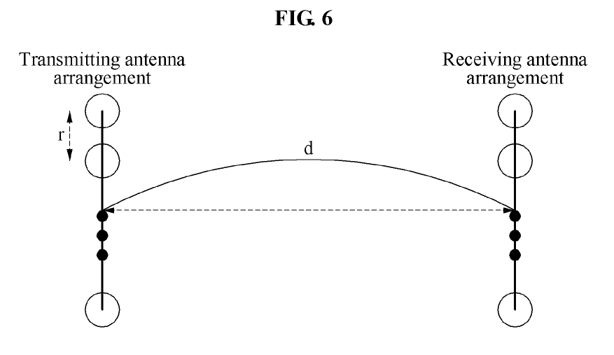

FIG. 6 is a diagram illustrating a simulation of MIMO communication in an LOS environment according to an example embodiment.

The LOS environment illustrated in FIG. 6 is assumed to be an ideal environment in which two separate data flows are present without scattering. In the simulation, a wavelength λ of a carrier signal, or a wavelength λ of a transmission signal, may be 5 millimeters (mm), and a distance d, or d₀, between a transmitter and a receiver may be 2 meters (m). A distance Lₜ between transmitting antennas and a distance Lᵣ between receiving antennas may be identical to each other as r.

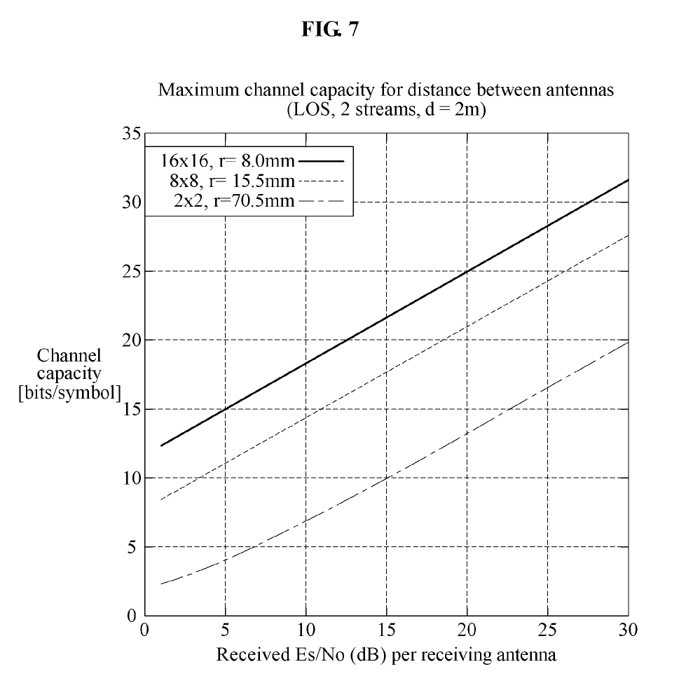

FIG. 7 is a graph illustrating a result of the simulation illustrated in FIG. 6.

Referring to FIG. 7, a channel capacity (bits/symbol) for a received energy per symbol to noise power spectral density (Es/No) (decibel [dB]) per receiving antenna may increase in response to an increase in the received Es/No per receiving antenna. In addition, the channel capacity may decrease in response to an increase in the distance r between the antennas.

According to example embodiments described herein, increasing a channel capacity in proportion to the number of antennas may be enabled by changing an arrangement or an attribute of a transmitting antenna or a receiving antenna for MIMO communication in an LOS environment.

The apparatuses, units, modules, devices, and other components that are described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing to instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods described according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A multiple-input and multiple-output (MIMO) communication method, the method comprising:
setting a target channel capacity between at least one transmitting antenna and at least one receiving antenna;
calculating a current channel capacity between the at least one transmitting antenna and the at least one receiving antenna based on a transmission signal output from the at least one transmitting antenna;
in response to the current channel capacity not meeting the target channel capacity, changing an arrangement or an attribute of the at least one transmitting antenna or the at least one receiving antenna, or a group to which the at least one transmitting antenna or the at least one receiving antenna belongs to adjust the transmission signal output from the at least one transmitting antenna.

2. The method of claim 1, wherein the changing comprises:
changing the arrangement or the attribute of the at least one transmitting antenna or the at least one receiving antenna to adjust a phase of the transmission signal.

3. The method of claim 1, wherein the changing comprises:
changing the arrangement or the attribute of the at least one transmitting antenna or the at least one receiving antenna, or the group to which the at least one transmitting antenna or the at least one receiving antenna belongs to adjust an amplitude of the transmission signal.

4. The method of claim 1, wherein the changing comprises:
changing a distance between the at least one transmitting antenna and the at least one receiving antenna.

5. The method of claim 1, wherein the changing comprises:
changing a distance between transmitting antennas or a distance between receiving antennas.

6. The method of claim 1, wherein the changing comprises:
changing an angle between transmitting antennas or an angle between receiving antennas.

7. The method of claim 1, wherein the changing comprises:
selecting a subgroup including a portion of transmitting antennas and receiving antennas.

8. The method of claim 1, wherein the changing comprises:
changing a reactance of at least one parasitic element,
wherein the at least one transmitting antenna or the at least one receiving antenna comprises an active element and the at least one parasitic element.

9. The method of claim 1, comprising:
calculating a current channel capacity between the changed at least one transmitting antenna and the changed at least one receiving antenna based on the changed arrangement or the changed attribute, or the changed group; and
changing, based on the calculated current channel capacity, the changed arrangement or the changed attribute, or the changed group.

10. The method of claim 1, wherein the setting comprises:
setting the target channel capacity to be a preset rate of a maximum channel capacity or a mean channel capacity calculated based on the arrangement or the attribute of the at least one transmitting antenna or the at least one receiving antenna.

11. A multiple-input and multiple-output (MIMO) communication apparatus, the apparatus comprising:
a channel capacity setter configured to set a target channel capacity between at least one transmitting antenna and at least one receiving antenna;
a channel capacity calculator configured to calculate a current channel capacity between the at least one transmitting antenna and the at least one receiving antenna based on a transmission signal output from the at least one transmitting antenna; and
in response to the current channel capacity not meeting the target channel capacity, an antenna changer configured to change an arrangement or an attribute of the at least one transmitting antenna or the at least one receiving antenna, or a group to which the at least one transmitting antenna or the at least one receiving antenna belongs to adjust the transmission signal output from the at least one transmitting antenna.

12. The apparatus of claim 11, wherein the antenna changer is configured to:
change a distance between the at least one transmitting antenna and the at least one receiving antenna, a distance between transmitting antennas, a distance between receiving antennas, an angle between the transmitting antennas, or an angle between the receiving antennas; or select a subgroup including a portion of the transmitting antennas and the receiving antennas.
